(19) United States
(12) Patent Application Publication
(10) Pub. No.: US 2024/0355111 A1
(43) Pub. Date: Oct. 24, 2024

(54) DYNAMIC LAYER PARTITIONING FOR INCREMENTAL TRAINING OF NEURAL RADIANCE FIELDS

(71) Applicant: Intel Corporation, Santa Clara, CA (US)

(72) Inventors: Alexey M. Supikov, Santa Clara, CA (US); Ronald Tadao Azuma, San Jose, CA (US)

(21) Appl. No.: 18/758,110

(22) Filed: Jun. 28, 2024

Related U.S. Application Data
(60) Provisional application No. 63/632,373, filed on Apr. 10, 2024.

(51) Int. Cl. G06V 10/82; G06T 7/20; G06T 7/90

(52) U.S. Cl. CPC G06V 10/82; G06T 7/20; G06T 7/90; G06T 2207/10024

(57) ABSTRACT

Example apparatus disclosed herein are to train a neural network based on initial video frames of an input video to generate neural representations of the initial video frames, the neural network having a first group of layers and a second group of layers, the first group of layers to be retrained for subsequent video frames after the initial video frames, the second group of layers to be selectively frozen for the subsequent video frames. Disclosed example apparatus are also to select a layer of the second group of layers to be unfrozen for a first video frame subsequent to the initial video frames, and retrain the first group of layers and the selected layer of the second group of layers to generate a neural representation of the first video frame, unselected ones of the second group of layers to remain frozen in the neural representation of the first video frame.

### RELATED APPLICATION(S)

This patent claims the benefit of U.S. Provisional Patent Application No. 63/632,373, which was filed on Apr. 10, 2024. U.S. Provisional Patent Application No. 63/632,373 is hereby incorporated herein by reference in its entirety. Priority to U.S. Provisional Patent Application No. 63/632,373 is hereby claimed.

### BACKGROUND

Machine learning models, such as neural networks, multi-layer perceptrons, etc., can be configured to implement a neural representation of a three-dimensional (3D) scene based on a set of two-dimensional (2D) images of the scene associated with a set of reference viewpoints. The neural representation, also referred to as a neural radiance field, is trained to encode structural and color information that can be used to render a 2D image of the scene from viewpoints that may be different from the reference viewpoints. A sequence of neural representations, or neural radiance fields, can also be trained to render respective video frames of a video of a 3D scene. As such, the sequence of neural representations, or sequence of neural radiance fields, form a neural video of the scene that can be rendered from different viewpoints and, thus, provide an immersive video experience.

### BRIEF DESCRIPTION OF THE DRAWINGS

FIGS. 1A-1B illustrate details of an example neural network that implements an example neural representation of a scene.

FIG. 2 illustrates an example incremental neural video (INV) multi-layer perceptron (MLP) with static layer partitioning.

FIG. 3 illustrates an example INV MLP with dynamic layer partitioning as disclosed herein.

FIG. 4 illustrates an example INV training circuit to train the example INV MLP with dynamic layer partitioning of FIG. 3 in accordance with teachings of this disclosure.

FIG. 5 illustrates example performance curves for the example INV MLP with static layer partitioning of FIG. 2 and the example INV MLP with dynamic layer partitioning of FIG. 3.

FIGS. 6 and 7A-7B are flowcharts representative of example machine readable instructions and/or example operations that may be executed, instantiated, and/or performed by example programmable circuitry to implement the INV training circuit of FIG. 4.

FIG. 8 is a block diagram of an example processing platform including programmable circuitry structured to execute, instantiate, and/or perform the example machine readable instructions and/or perform the example operations of FIGS. 6 and 7A-7B to implement the INV training circuit of FIG. 4.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 6 and 7A-7B) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Images, audio, video, 3D objects, and most media, are typically captured and represented by discrete samples. For example, an image is typically represented as a grid of discrete samples, such as an array of pixels, where each pixel has numbers representing the intensity at that image location in red, green, and blue colors. In contrast, a neural representation is a neural network that stores content, such as an image, in the weights and structure of the neural network. For example, such a neural network may receive (x, y, z) coordinates as input and output (R, G, B) pixel values that represent a color distribution in 3D space. Neural Radiance Fields (NeRFs) are a specific neural representation that trains a neural network (e.g., . . . a multilayer perceptron (MLP)) to represent the appearance of a 3D scene. A NeRF takes as input several images of a static scene, where the cameras are at known locations, and uses deep learning techniques to train the neural network to implement a neural representation of that scene.

Incremental neural video (INV) is an immersive video representation technique that creates and streams NeRFs generated from multi-view video streams by using incremental training and freezing of different groups of a NeRF's multi-layer perceptron (MLP) layers. Weight freezing is important for compression during streaming. In some scenarios, only 27%-36% of the MLP layers are changed with each new frame, while the rest of the layers stay frozen. Also, prior INV implementations use static partitioning of the MLP layers into frozen layers and trained layers. However, with real-world, long videos with changing content, static partitioning may lead to image quality degradation that increases through the duration of the video. In contrast, INV with dynamic layer partitioning, as disclosed, herein enables dynamic selection of the trained and frozen layers, resulting in improved image quality on long video sequences with little impact on compression and performance.

For reference, NeRFs use deep learning to train a neural network that represents the density and appearance of a scene. NeRFs have demonstrated the ability to accurately represent 3D scenes with complex geometry and light transport. A NeRF uses a neural network called a multi-layer perceptron (MLP) which is relatively deep (e.g., 11 fully connected layers). However, early NeRF techniques were limited to representation of static scenes and were not suitable for three-dimensional (3D) videos.

INV is a NeRF-based technique that supports the creation and streaming of 3D video scenes based on incoming multi-view video streams. INV is based on training a NeRF incrementally by reusing MLP weights from a previous frame to train the neural network (e.g., MLP) for a new frame, and leveraging the discovery of spontaneous partitioning of the network into motion related layers and color related layers. In some examples, the motion related layers are the 3-4 initial layers of the MLP that change during incremental training for new frames. In some examples, the color related layers are the 7-8 last layers of the MLP that show little or no change when trained incrementally. Experiments have shown that the changing 3-4 initial layers of the INV MLP are primarily responsible for motion and deformations, whereas the 7-8 later layers are primarily responsible for the color distributions across scene fragments.

INV introduced a new way to train the MLP to create neural videos. Previously, INV incrementally trained the entire MLP for the few first frames of the video and then froze the slow-changing, color related layers for the remaining duration of the video. Thus, only the first 3-4 motion-related layers were trained throughout the video, whereas the remaining 7-8 color-related layers stayed frozen after the initial few frames of the video. Freezing the color related layers, rather than training all layers throughout the video, resulted in improved video consistency and reduced computation requirements for training, and improved compression by over a factor of 3, since only changes in 3-4 initial MLP layers were compressed and transmitted to a client.

However, in prior INV techniques, the partitioning of layers into trained and frozen layers was static, with the first 3-4 layers being trained whereas the rest of the layers are frozen. Such static partitioning can lead to peak signal-to-noise ratio (PSNR) degradation on long videos having dynamic changes. Experiments have shown that such behavior was caused by the network trying to adjust the motion-related layers to respond to changes in color distributions when new content appears in the video.

One approach to remedy such PSNR degradation could involve either increasing the number of training iterations to force the motion-related layers to absorb the color change or unfreezing the color-related layers when PSNR degradation is detected. However, both approaches could lead to undesired consequences, such as an increase in training time, an increase in transmitted data size, sudden jumps in image quality, etc.

Instead of a static partitioning of layers into frozen and trained, INV with dynamic layer partitioning as disclosed herein sets the initial x layers of an N-layer NeRF as trainable throughout the video, and selects one (or a subset) of the remaining y=N−x frozen layers to be unfrozen and trained for a given frame. Furthermore, in some examples, the particular one (or subset) of the remaining y=N−x layers selected to be unfrozen is forced to change from frame to frame or, in other words, the same layer (or subset of layers) is not permitted to be unfrozen for adjacent frames. For example, INV with dynamic layer partitioning as disclosed herein may keep the initial 3 layers of an 11-layer NeRF as trainable throughout the video, and select one of the remaining 8 layers to be unfrozen and trained for the training duration of a given frame. Thus, in such an example, for each video frame, INV with dynamic layer partitioning trains 3 front and one of the 8 back layers, allowing the network to adjust for changes in color distributions in the video over time. As disclosed in further detail below, the selection of the layer(s) to unfreeze is driven by statistics of loss function improvement accumulated for the frozen layers over previous frames.

It is to be noted that the specific numbers, such 11 layers and the 3:8 or 4:7 ratios of trained to frozen layers, are examples. INV with dynamic weight partitioning, as disclosed herein, can be generalized to other network architectures and content.

INV with dynamic layer partitioning provides several advantages. For example, INV with dynamic layer partitioning solves the problem of representing and streaming long neural 3D videos with large changes while maintaining high quality, and at just marginal extra compute or bandwidth cost. INV with dynamic layer partitioning is also able to create and stream 3D neural videos of any length, which enables immersive applications such, as telepresence/teleconferencing, free-viewpoint 3D instructional videos, game streaming, augmented reality (AR) and/or virtual reality (VR) applications, etc., to be implemented and deployed on platforms with current generation graphics processing units (GPUs) and/or next generation GPUs, network processing units (NPUs), etc.

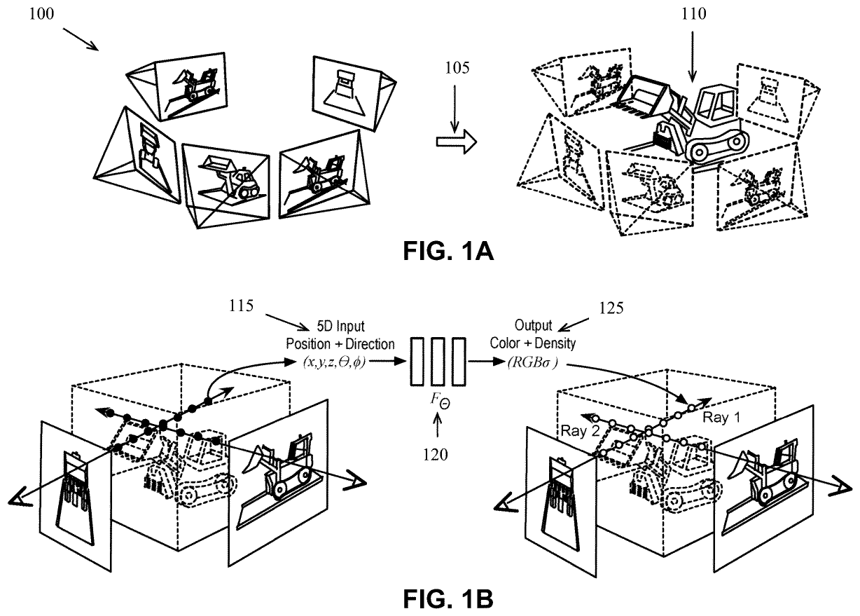

FIGS. 1A-1B illustrate details of an example NeRF neural network. FIG. 1A shows conceptual diagrams of training a NeRF. FIG. 1B shows input and output details of a NeRF neural network. As shown in FIG. 1A, several images 100 may be taken of a three-dimensional scene (3D) from known locations. A training operation 105 can be performed to build a neural representation of that 3D scene from those images. The trained neural representation is a NeRF that represents the scene via the weights of the neural network model. The NeRF can be used to render the scene 110 from viewpoints other than the viewpoints of the input images. As shown in FIG. 1B, a trained NeRF can receive a five-dimensional (5D) input 115 that includes a 3D position (x, y, z) and a 2D direction (θ and Φ). The NeRF can be a neural network 120 (F_{θ}), such as an MLP, that is trained to produce an output 125 color value (R,G,B) and density o in response to the 5D input 115. Volume rendering techniques can repeatedly access the neural network 120 to render the 3D scene from an arbitrary viewpoint to accumulate colors and densities into a 2D image.

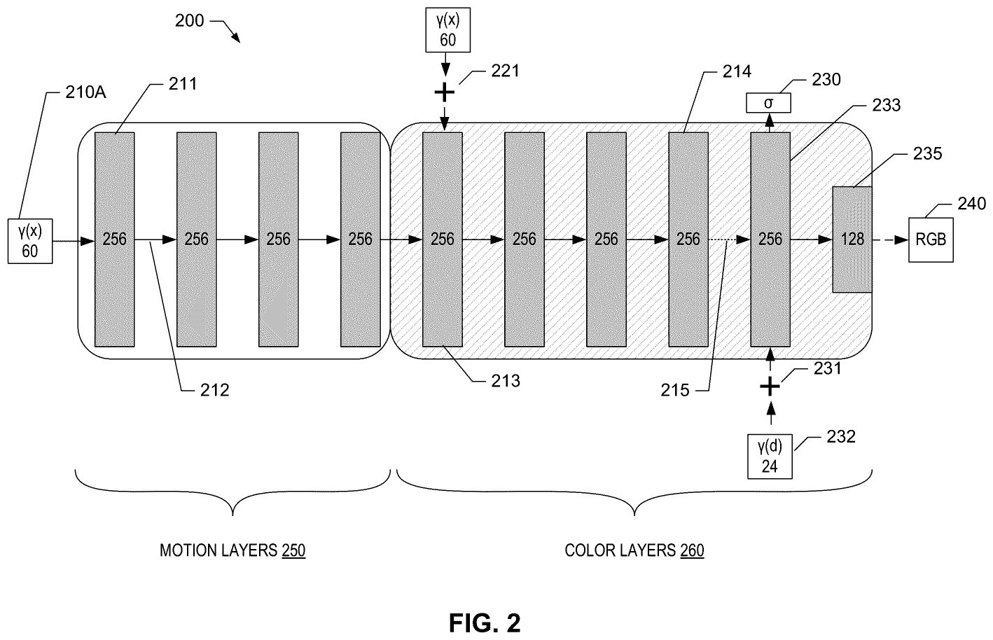

FIG. 2 illustrates an example neural network 200 that implements an INV MLP with static layer partitioning. The neural network model 200 is an MLP, which is a fully connected neural network that is used for NeRF implementations. The neural network model 200 of the illustrated example includes multiple fully connected layers 211, each with 256 channels and an example rectified liner unit (ReLU) activation function 212. An example positional input 210A (γ(x), e.g., 3D-position (x, y, z) is provided at the first fully connected layer 211 and propagates through eight fully connected layers. An additional instance of the positional input 210B is provided via a skip connection to an example fifth fully connected layer 213. The positional input 210B is combined with the fifth fully connected layer 213 via vector concatenation using an example combining function 221. An example eighth fully connected layer 214 outputs a first example output layer 233, which outputs an example volume density 230 for the position γ(x) and a 256-dimension feature vector. The 256-dimension feature vector is concatenated via an example combining function 231 with an example viewing direction 232 (γ(d), e.g., 2D direction (θ, Φ)) and processed via a second example output layer 235 to generate an example RGB value 240 for the position γ(x) when viewed from direction γ(d). Instead of using positions x and direction d inputs directly, the neural network 200 applies an encoding function γ to convert 3 position coordinates x to multichannel inputs with 60 channels for position, and to convert 2 direction coordinates d to 24 channels for direction, for example. The use of encoding function can improve the ability of the neural network to represent high frequencies. Examples of the encoding function y include frequency encoding, Fourier features, multi-resolution hash tables, etc.

The neural network 200 enables the synthesis of new images of a 3D scene as seen from a desired viewpoint at a specific time, even if that viewpoint was not directly captured by a video camera. The neural network 200 also supports INV with static layer partitioning. As described above, the INV approach takes as input multiple video streams with camera parameters (e.g., intrinsic and/or extrinsic parameters) for each stream, where each stream captures the same scene from a different viewpoint. INV maintains a NeRF-like MLP, such as the neural network 200, that is up to date with the current timestamp of the video streams. The NeRF-like MLP 200 is incrementally updated for each incoming multi-view frame (corresponding to multiple views in space at a given frame time). Incremental training uses MLP weights from the previous frame to train the MLP 200 for the next frame. Therefore, the MLP 200 can automatically re-use learning from previous frames and adjusts the MLP layer weights for a new frame. In this frame-to-frame incremental training mode, the MLP weights exhibit the following behavior: the front layers change from frame to frame, whereas the back layers change slowly or remain unchanged. Such behavior happens spontaneously in the INV NeRF MLP 200. As described above, experiments have shown that the front layers of the MLP 200 are mainly responsible for encoding motion/deformation, whereas the back layers mainly encode color of the 3D scene fragments. Capitalizing on that finding, prior INV approaches employ static layer partitioning in which all layers of the MLP 200 are trained during a warm-up period and then the back, color-related layers are frozen for the remaining duration of video. The full MLP 200 is sent to clients only once, in the beginning of the video sequence, and then only compressed changes of the un-frozen layers are transmitted for subsequent frames.

FIG. 2 schematically depicts example trainable layers 250 and example frozen layers 260 of the MLP 200 for an INV implementation that employs static layer partitioning. The decision on which layers are frozen (e.g., the layers 260) or trainable (e.g., the layers 250) is made once at the start of the video and stays the same for the entire streaming session. Such static partitioning may result in slow PSNR degradation on long video sequences with large changes.

To mitigate this problem and make the MLP capture the changes over the duration of a video, one option could be to increase the number of training iterations (e.g., by at least a factor of 4) or un-freeze and train the back, color-related layers 260. However, unfreezing all color-related layers 260 would negatively affect the MLP compression ratio (e.g., from a factor of 13× down to a factor 4.5×). Unfreezing all color-related layers 260 just temporarily when the image quality degrades also causes image quality jumps and lacks clear criteria for making un-freezing decisions because PSNR jitters from frame-to-frame due to the stochastic nature of optimization.

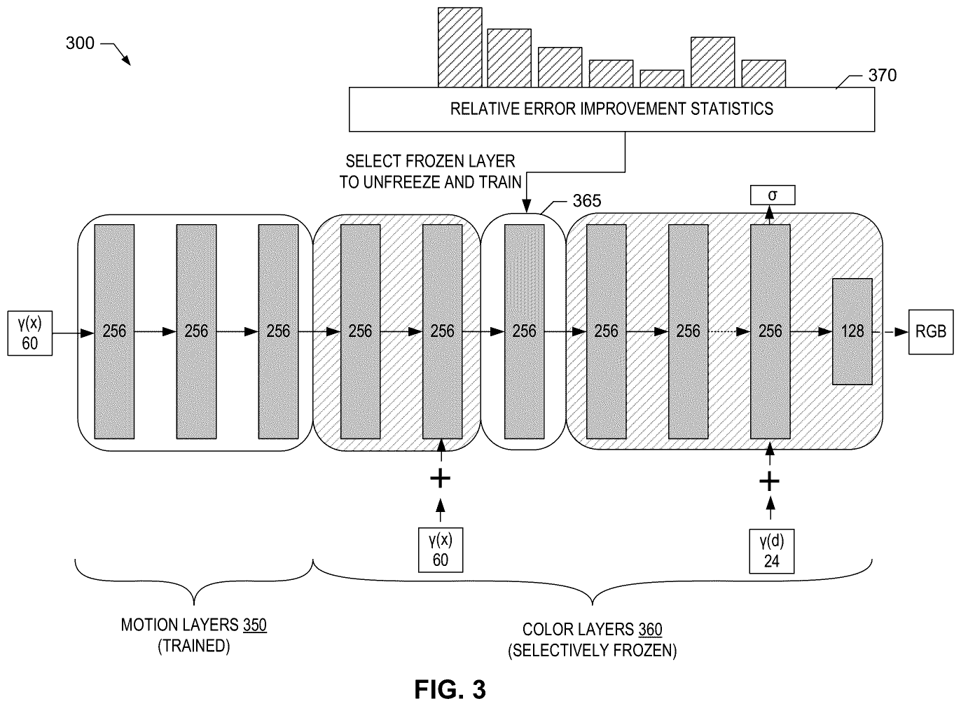

In contrast, FIG. 3 illustrates an example neural network 300 that implements an INV MLP with dynamic layer partitioning. The neural network 300 has a similar structure as the neural network 200 of FIG. 2. However, in the illustrated example of FIG. 3, the back, color-related layers 360 of the neural network 300, also referred to as the MLP 300, are selectively unfrozen and trained throughout the duration of the video, but at a lower rate than the front, motion-related layers 350. For example, out of the budget of trainable layers, INV with dynamic layer partitioning may select just one layer 365 of the back color-related layers 360 of the MLP 300 to be trained per frame, with the selected layer 365 being changed across successive (e.g., adjacent) frames. This trainable back layer 365 is dynamically selected for each successive frame after a warm-up training period. The rest of the layers that are trained are the front, motion-related layers 350 to quickly respond to motion in the scene. Furthermore, in some examples, the selected back layer 365 is trained for an entire frame time (timestamp) to guarantee the same amount of data is changed and sent to the clients every frame. In the illustrated example, back color layer 365 to train is selected by tracking example relative error improvements statistics 370, as described below.

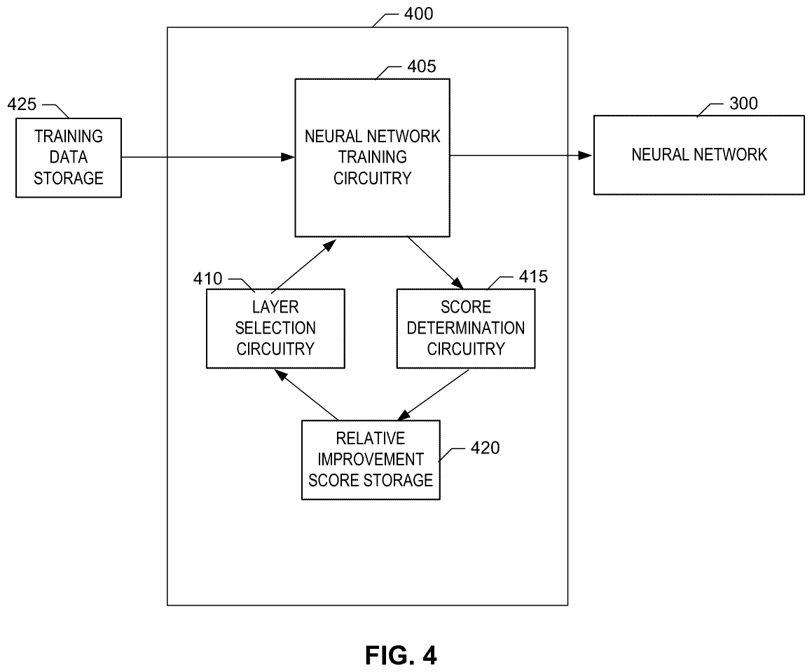

FIG. 4 is a block diagram of an example INV training circuit 400 to train the neural network 300 of FIG. 3 to implement an INV MLP with dynamic layer partitioning. The INV training circuit 400 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the INV training circuit 400 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example INV training circuit 400 includes example neural network training circuitry 405, example layer selection circuitry 410, example score determination circuitry 415, and example relative improvement score storage 420. The neural network training circuitry 405 implements any appropriate neural network training technique or combination of techniques to train the layer weights of the neural network 300 incrementally to implement an INV based on training data stored in example training data storage 425. In the illustrated example, the training data storage 425 can be implemented by any number and/or types of storage devices, memories, etc., and stores training data including multiple video streams from different viewpoints of a 3D scene, which collectively form multi-view video frames of an input video. In the illustrated example, the neural network training circuitry 405 can implement forward propagation techniques, backward propagation techniques, etc., or any combination thereof, to incrementally train the neural network 300 based on the multi-view video streams stored in the training data storage 425 to implement an INV that outputs a stream of NeRFs that enable video frames to be rendered from viewpoints other than the viewpoints of the input multi-view video streams. Further example training techniques that can be implemented by the neural network training circuitry 405 are described in U.S. Patent Publication No. 2024/0135483, which is titled “INCREMENTAL NEURAL REPRESENTATION FOR FAST GENERATION OF DYNAMIC FREE-VIEWPOINT VIDEOS,” and which was published on Apr. 25, 2024.

In the illustrated example of FIG. 4, the layer selection circuitry 410 of the INV training circuit 400 selects one layer 365 (or a subset of layers) of the frozen, back color-related layers 360 of the neural network 300 (e.g., the MLP 300) to be trained per frame, with the selected layer 365 (or subset of layers) being changed across successive (e.g., adjacent) frames. In some examples, the frozen back layer 365 (or subset of layers) to be unfrozen and trained is dynamically selected by the layer selection circuitry 410 for each successive frame after a warm-up training period.

In the illustrated example, the layer selection circuitry 410 selects the layer 365 (or a subset of layers) of the frozen, back color-related layers 360 of the MLP 300 based on relative error improvements statistics 370 determined by the score determination circuitry 415 of the INV training circuit 400. In some examples, the score determination circuitry 415 tracks the relative error improvements statistics 370 over a sliding window of, for example, 40-60 frame timestamps. The selection schedule implemented by the layer selection circuitry 410 uses the relative error improvements statistics 370 determines by the score determination circuitry 415, which helps ensure that each frozen layer of the neural network 300 has a fair chance to be selected for training, with a bias towards frozen layers that exhibit greater reductions in loss after additional training.

In some examples, after a warm-up period, the layer selection circuitry 410 starts by selecting a given frozen back layer 365 (or subset of layers) from the set of frozen back layers 360 for training the neural network 300 for successive multi-view video frames one after another in round robin fashion. For each selected layer 365, the score determination circuitry 415 keeps track of a relative error improvement statistics 370, such as a loss improvement score, which may be an accumulated relative loss improvement computed at the end of the frame training from mean ray training loss over the frame. In some examples, the score determination circuitry 415 computes the mean ray loss improvement relative to the loss improvement computed for a previous frame. In some examples, if the loss did not improve at the current frame (e.g., got worse), the score determination circuitry 415 does not update the loss improvement score for the selected unfrozen layer 365. In that way, the score determination circuitry 415 can mitigate the diminishing loss improvement as training progresses and ignore sudden loss jumps due to the stochastic nature of the optimization. In the illustrated example, the score determination circuitry 415 stores the relative error improvements statistics 370 (e.g., the loss improvement score) for the frozen layers 360 of the neural network in the example relative improvement score storage 420, which may be implemented by any number and/or types of data storage, memories, etc.

In some examples, after a sliding window (e.g., 40-60 frames) of per-layer loss improvement scores are accumulated by the score determination circuitry 415, the layer selection circuitry 410 switches from the round robin layer selection process to sampling from a loss improvement distribution as follows. For example, before training for a new frame, the layer selection circuitry 410 retrieves the respective loss improvement scores for the frozen back layers 360 of the neural network 300 from the relative improvement score storage 420 and normalizes the loss improvement scores for the frozen back layer 360 by the sum of the loss improvement scores (e.g., for all 8 back layers). This operation creates a loss improvement distribution that specifies respective probabilities of unfreezing the corresponding different back layers 360. In some examples, the layer selection circuitry 410 performs inverse sampling to pick a frozen layer 365 (or subset of layers) from the frozen back layers 360 using the loss improvement distribution. Because the number of layers is small, the layer selection circuitry 410 can implement a binary search to implement inverse sampling of the loss improvement distribution. In some examples, to prevent permanent freezing of layers having near-zero probability, the layer selection circuitry 410 clamps the probabilities for the frozen back layers 360 from below by a small threshold (e.g., 0.02 or some other value) and renormalizes the probabilities before the inverse sampling. In this way, the INV training circuit 400 implements INV with dynamic layer partitioning that can favor back layers 360 with the best training return on investment (ROI) without completely excluding layers with no ROI.

In view of the foregoing, in some examples, the neural network training circuitry 405 of the INV training circuit 400 trains the neural network 300 based on initial multi-view video frames of an input video (e.g., accessed from the training data storage 425) to generate neural representations (e.g., NeRFs) of the initial video frames, with the neural network 300 having a first group of layers 350 and a second group of layers 360, the first group of layers 350 to be retrained for subsequent video frames of the video after the initial video frames (e.g., after a warm-up period), and the second group of layers 360 to be selectively frozen for the subsequent video frames. In some such examples, the layer selection circuitry 410 of the INV training circuit 400 selects at least one layer 365 of the second group of layers 360 to be unfrozen for a first video frame subsequent to the initial video frames (e.g., subsequent to the warm-up period). In some such examples, the neural network training circuitry 405 then retrains the first group of layers 350 and the selected at least one layer 365 of the second group of layers 360 to generate a neural representation (e.g., a NeRF) of the first video frame, with unselected ones of the second group of layers to remain frozen in the neural representation of the first video frame.

In some examples, the at least one layer is at least one first layer of the second group of layers 360, and the layer selection circuitry 410 is to select at least one second layer of the second group of layers 360 to be unfrozen for a second video frame subsequent to the first video frame, with the at least one second layer different from the at least one first layer that was selected for the preceding first video frame. In some such examples, the neural network training circuitry 405 is to retrain the first group of layers 350 and the selected at least one second layer of the second group of layers 360 to generate a neural representation (e.g., NeRF) of the second video frame, with unselected ones of the second group of layers to remain frozen in the neural representation of the second video frame.

In some examples, the at least one layer of the second group of layers 360 selected by the layer selection circuitry 410 to be unfrozen for the first video frame includes at least two layers of the second group of layers 360.

In some examples, the layer selection circuitry 410 is to select the at least one layer 365 of the second group of layers 360 based on a round-robin procedure.

In some examples, the layer selection circuitry 410 is to select the at least one layer 365 of the second group of layers 360 based on scores (e.g., loss improvement scores) determined by the score determination circuitry 415 of the INV training circuit 400 for respective ones of the second group of layers 360. In some such examples, the layer selection circuitry 410 is to convert the scores to selection probabilities for the respective ones of the second group of layers 360, and select the at least one layer 365 of the second group of layers 360 based on the selection probabilities (e.g., using inverse sampling as described above).

In some examples, the at least one layer selected for the first video frame is at least one first layer of the second group of layers 360, and the layer selection circuitry 410 is to select the at least one first layer of the second group of layers 360 for the first video frame based on a round-robin procedure. In some such examples, the layer selection circuitry 410 is to select at least one second layer of the second group of layers 360 to be unfrozen for a second video frame subsequent to the first video frame, with the at least one second layer to be selected based on scores (e.g., loss improvement scores) determined by the score determination circuitry 415 for respective ones of the second group of layers 360.

In some examples, the first group of layers 350 of the neural network 300 includes a first number (e.g., 3 or 4) of front layers of the neural network 300, and the second group of layers 360 of the neural network 300 includes a second number (e.g., 7 or 8) of back layers of the neural network. In some examples, the first group of layers 350 of the neural network 300 is associated with motion represented by the neural representations, and the second group of layers 360 of the neural network 300 is associated with color represented by the neural representations. In some examples, the trained neural representations of the video frame of the input video are stored in memory and/or transmitted to a destination compute device (e.g., such as a computer, a media device, a headset, etc.).

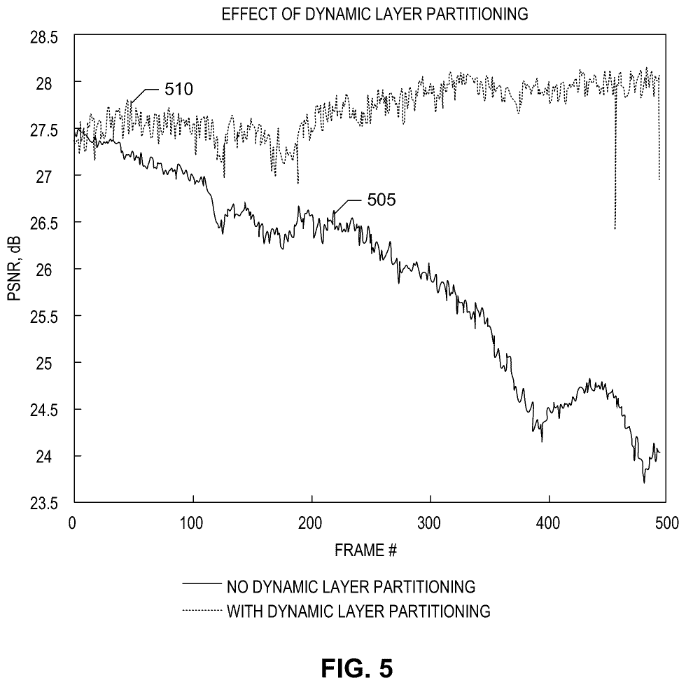

FIG. 5 illustrates example performance curves 505 and 510, respectively, for the example INV MLP 200 with static layer partitioning of FIG. 2 and the example INV MLP 300 with dynamic layer partitioning of FIG. 3. The performance curves 505 and 510 are based on experiments performed with the same data, the same number of iterations per frame and the same post-warmup starting point. As shown by the performance curves 505 and 510, the INV MLP 300 with dynamic layer partitioning improves quality on incremental neural videos by 2-4 dB relative to the INV MLP 200 with static layer partitioning without increasing training or rendering computations, and within the same streaming bandwidth requirements. Note that over time, the INV MLP 200 with static layer partitioning declines in PSNR because the scene changes significantly (see the curve 505), whereas the INV MLP 300 with dynamic layer partitioning maintains the original PSNR (see the curve 510).

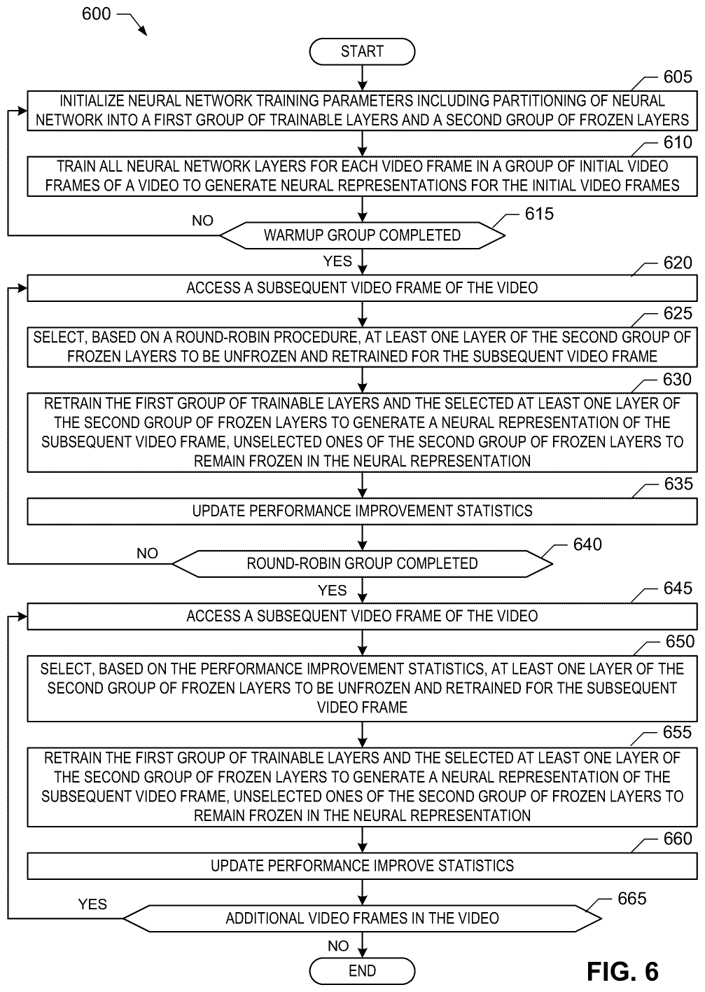

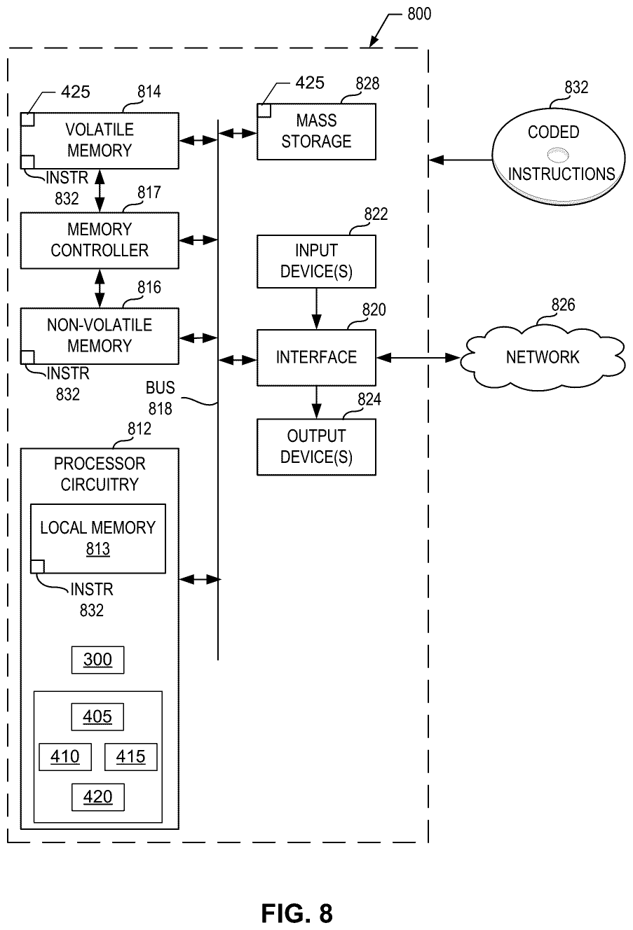

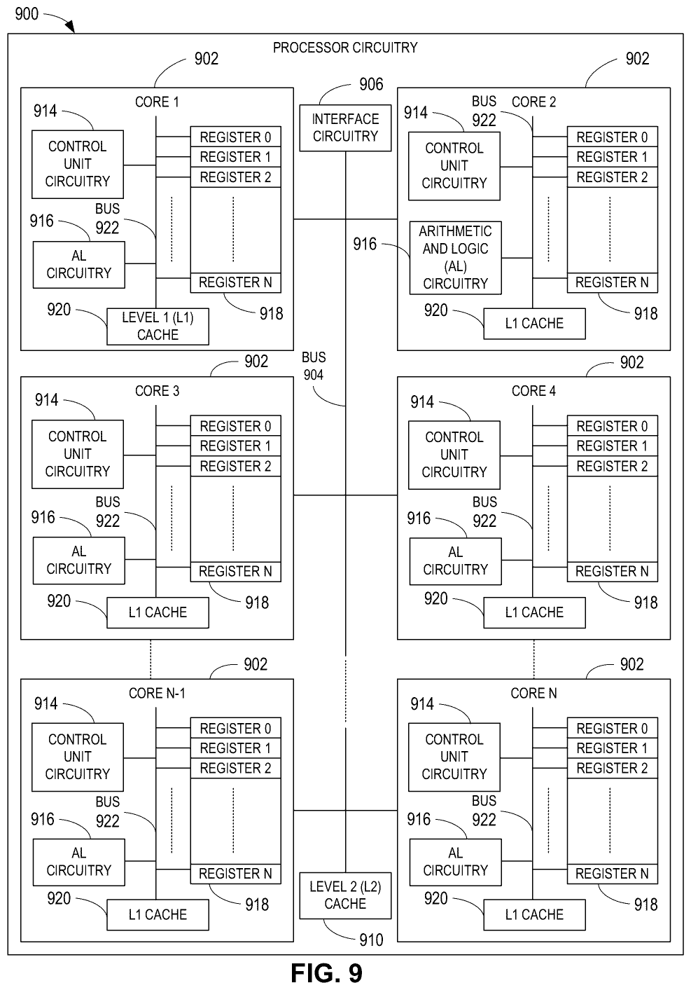

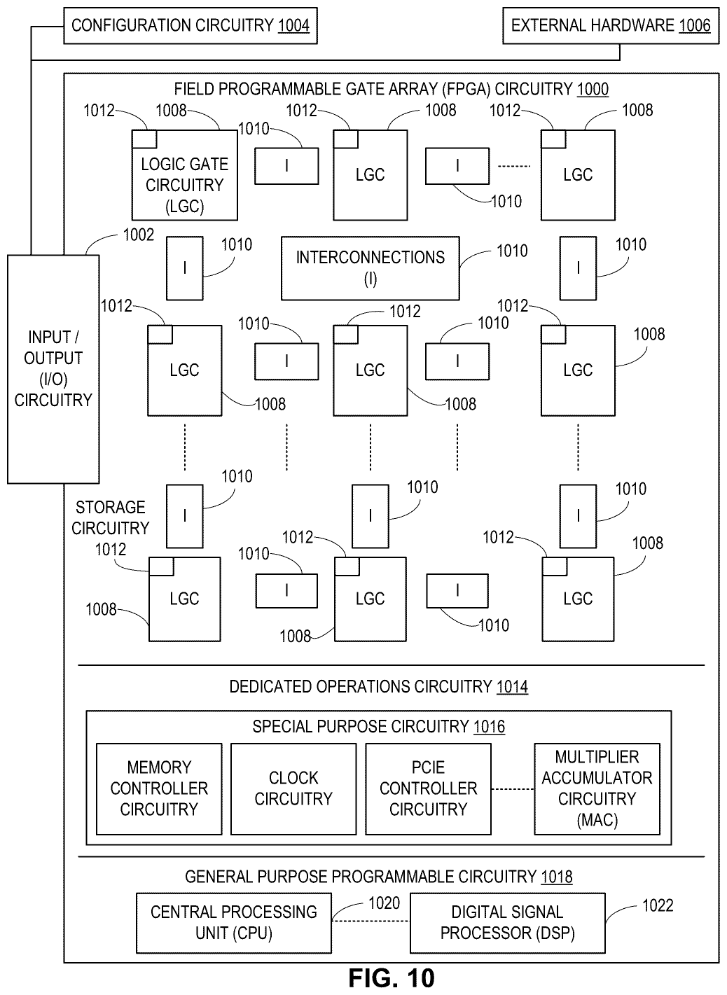

In some examples, the INV training circuit 400 includes means for training a neural network. For example, the means for training a neural network may be implemented by the neural network training circuitry 405. In some examples, the neural network training circuitry 405 may be instantiated by programmable circuitry such as the example programmable circuitry 812 of FIG. 8. For instance, the neural network training circuitry 405 may be instantiated by the example microprocessor 900 of FIG. 9 executing machine executable instructions such as those implemented by blocks of FIGS. 6 and/or 7A-7B. In some examples, the neural network training circuitry 405 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the neural network training circuitry 405 may be instantiated by any other combination of hardware, software, and/or firmware. For example, the neural network training circuitry 405 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the INV training circuit 400 includes means for selecting frozen neural network layers to be trainable. For example, the means for selecting frozen neural network layers to be trainable may be implemented by the layer selection circuitry 410. In some examples, the layer selection circuitry 410 may be instantiated by programmable circuitry such as the example programmable circuitry 812 of FIG. 8. For instance, the layer selection circuitry 410 may be instantiated by the example microprocessor 900 of FIG. 9 executing machine executable instructions such as those implemented by blocks of FIGS. 6 and/or 7A-7B. In some examples, the layer selection circuitry 410 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the layer selection circuitry 410 may be instantiated by any other combination of hardware, software, and/or firmware. For example, the layer selection circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the INV training circuit 400 includes means for determining relative improvement scores for frozen neural network layers. For example, the means for determining relative improvement scores for frozen neural network layers may be implemented by the score determination circuitry 415. In some examples, the score determination circuitry 415 may be instantiated by programmable circuitry such as the example programmable circuitry 812 of FIG. 8. For instance, the score determination circuitry 415 may be instantiated by the example microprocessor 900 of FIG. 9 executing machine executable instructions such as those implemented by blocks of FIGS. 6 and/or 7A-7B. In some examples, the score determination circuitry 415 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the score determination circuitry 415 may be instantiated by any other combination of hardware, software, and/or firmware. For example, the score determination circuitry 415 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the INV training circuit 400 is illustrated in FIG. 4, one or more of the elements, processes, and/or devices illustrated in FIG. 4 may be combined, divided, re-arranged, omitted, eliminated, and/or implemented in any other way. Further, the example neural network 300, the example neural network training circuitry 405, example layer selection circuitry 410, example score determination circuitry 415, and example relative improvement score storage 420, the example training data storage 425, and/or, more generally, the example INV training circuit 400 of FIG. 4, may be implemented by hardware alone or by hardware in combination with software and/or firmware. Thus, for example, any of the example neural network 300, the example neural network training circuitry 405, example layer selection circuitry 410, example score determination circuitry 415, and example relative improvement score storage 420, the example training data storage 425, and/or, more generally, the example INV training circuit 400, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example INV training circuit 400 may include one or more elements, processes, and/or devices in addition to, or instead of, those illustrated in FIG. 4, and/or may include more than one of any or all of the illustrated elements, processes and devices.

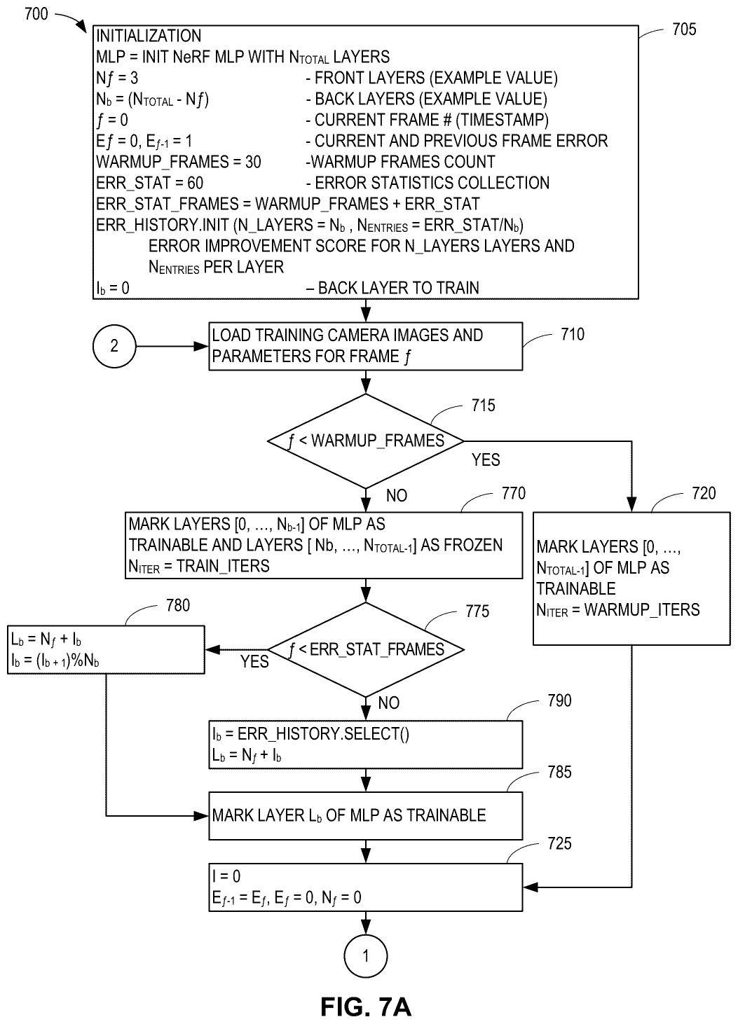

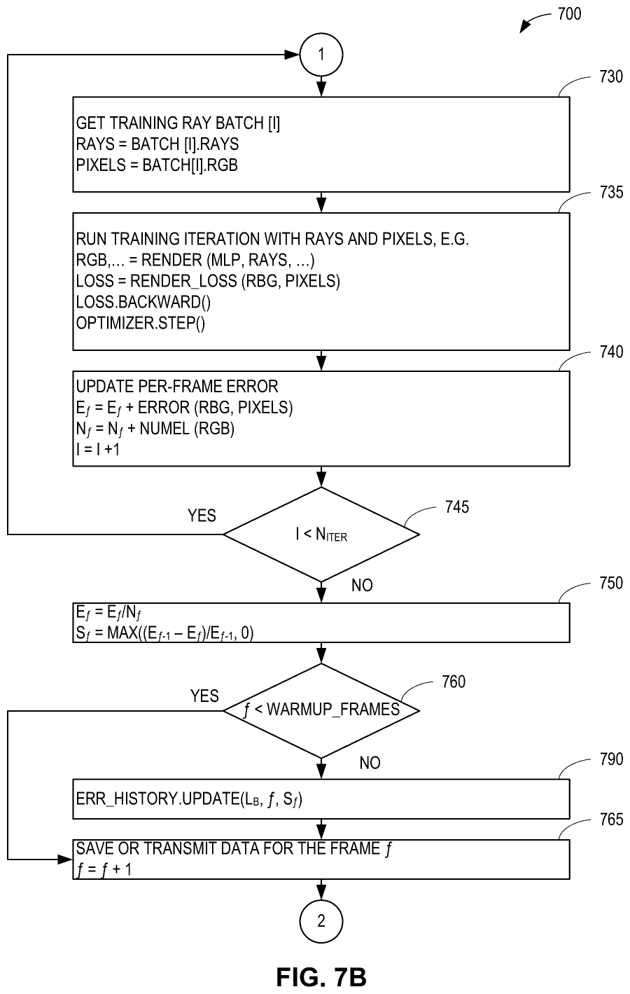

Flowchart(s) representative of example machine readable instructions, which may be executed by programmable circuitry to implement and/or instantiate the INV training circuit 400 of FIG. 4 and/or representative of example operations which may be performed by programmable circuitry to implement and/or instantiate the INV training circuit 400 of FIG. 4, are shown in FIGS. 6 and 7A-7B. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6 and 7A-7B, many other methods of implementing the example INV training circuit 400 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 6 and 7A-7B may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to implement the INV training circuit 400 of FIG. 4. The example machine-readable instructions and/or the example operations 600 of FIG. 6 begin at block 605, at which the neural network training circuitry 405 initializes the neural network training parameters for training the neural network 300, which includes partitioning the neural network 300 into the first group of trainable layers 350 and a second group of frozen layers 360. At block 610, the neural network training circuitry 405 trains all neural network layers of the neural network 300 for each multi-view video frame in a group of initial multi-view video frames of an input video having multiple streams from different viewpoints to generate neural representations (e.g., NeRFs) for the initial video frames, as described above. The initial video frames correspond to a warmup period for training the neural network 300. At block 615, the layer selection circuitry 410 determines whether the warmup period is completed.

If the warmup period is completed, at block 620 the neural network training circuitry 405 accesses a subsequent multi-video video frame of the video (e.g., from the training data storage 425). At block 625, the layer selection circuitry 410 selects, based on a round-robin procedure as described above, at least one layer of the second group of frozen layers 360 to be unfrozen and retrained for the subsequent video frame. At block 630, the neural network training circuitry 405 retrains the first group of trainable layers 350 and the selected at least one layer of the second group of frozen layers 360 to generate a neural representation (e.g., a NeRF) of the subsequent video frame, with unselected ones of the second group of frozen layers 360 to remain frozen in the neural representation of the subsequent video frame. At block 635, the score determination circuitry 415 updates the performance improvement statistics for the second group of frozen layers 360 and stores the performance improvement statistics in the relative improvement score storage 420. For example, the score determination circuitry 415 updates the performance improvement statistics for the second group of frozen layers 360 by updating the relative loss improvement score for the selected at least one layer of the second group of frozen layers 360, as described above. Processing at blocks 620-635 repeats for subsequent video frames until a round-robin group of training frames is completed.

At block 640, the layer selection circuitry 410 determines whether the round-robin group of training frames is completed. If so, at block 645 the neural network training circuitry 405 accesses a subsequent multi-video video frame of the video (e.g., from the training data storage 425). At block 650, the layer selection circuitry 410 selects, based on performance improvement statistics as described above, at least one layer of the second group of frozen layers 360 to be unfrozen and retrained for the subsequent video frame. At block 655, the neural network training circuitry 405 retrains the first group of trainable layers 350 and the selected at least one layer of the second group of frozen layers 360 to generate a neural representation (e.g., a NeRF) of the subsequent video frame, with unselected ones of the second group of frozen layers 360 to remain frozen in the neural representation of the subsequent video frame. At block 660, the score determination circuitry 415 updates the performance improvement statistics for the second group of frozen layers 360 and stores the performance improvement statistics in the relative improvement score storage 420. For example, the score determination circuitry 415 updates the performance improvement statistics for the second group of frozen layers 360 by updating the relative loss improvement score for the selected at least one layer of the second group of frozen layers 360, as described above. Processing at blocks 645-660 repeats for subsequent video frames until the completion of the video.

At block 640, the layer selection circuitry 410 determines whether training for all frames of the video is completed. If so, the example machine-readable instructions and/or the example operations 600 end.

FIGS. 7A-7B are collectively a flowchart representative of second example machine readable instructions and/or example operations 700 that may be executed, instantiated, and/or performed by programmable circuitry to implement the INV training circuit 400 of FIG. 4. The example machine-readable instructions and/or the example operations 700 of FIGS. 7A-7B begin at block 705 of FIG. 7A, at which the neural network training circuitry 405 initializes the neural network training parameters for training the neural network 300. The parameter initialization includes partitioning the neural network 300 into the first group of trainable layers 350 (corresponding to Nf in FIG. 7A) and a second group of frozen layers 360 (corresponding to Nb in FIG. 7A), and setting the warmup period (e.g., corresponding to 30 frames in FIG. 7A). At block 710, the neural network training circuitry 405 loads the training camera images and parameters for the current frame of the video for which a neural representation (e.g., NeRF) is to be trained. At block 715, the layer selection circuitry 410 determines whether the current frame is within the warmup period. If so, at block 720, the layer selection circuitry 410 marks all layers of the neural network 300 as trainable and the neural network training circuitry 405 initializes the number of training iterations to be performed for the current frame. At block 725, the neural network training circuitry 405 begins iterating over the training batches for the current frame.

For example, at block 730 of FIG. 7B, the neural network training circuitry 405 accesses a batch of training rays to be rendered for the current frame and a batch of pixels of the current frame that are intersected by the training rays. At block 735, the neural network training circuitry 405 runs a training iteration of the neural network 300 for the current frame and the batch of training ray data. For example, at block 735, the neural network training circuitry 405 invokes neural network 300 (e.g., MLP 300) to generate a neural representation based on locations and directions of the training rays, and performs an optimization procedure to update the weights of the neural network layers marked as trainable by the layer selection circuitry 410 for the current layer. At block 735, the optimization procedure may be based on error (e.g., loss) computed between the neural representation generated by the neural network 300 and the training pixels of the current training batch.

At block 740, the score determination circuitry 415 updates a per-frame error metric that is based on an error (e.g., loss) computed between the neural representation generated by the neural network 300 and the training pixels of the current training batch, and also tracks the number of pixels that have been output by the neural network 300 during training of the current frame. At block 740, the neural network training circuitry 405 also increments the training batch iteration count. At block 745, the neural network training circuitry 405 determines causes additional training batches to be run for the current frame until the initialized number of training batch iterations has been reached. When that occurs, at block 750, the score determination circuitry 415 determines a final error metric for the current frame by normalizing the accumulated error by the number of pixels output by the neural network 300 during training of the current frame. At block 760, the layer selection circuitry 410 determines whether the current frame is still within the warmup period. If so, at block 765 the neural network training circuitry 405 causes the trained parameters (e.g., weights) of the neural network 300 to be saved or output (e.g., transmitted) as a neural representation (e.g., NeRF) for the current frame. The neural network training circuitry 405 then increments the frame index to access the next, subsequent frame of the video, and processing returns to block 710 of block 7A at which the neural network training circuitry 405 accesses loads the training camera images and parameters for the next, subsequent frame of the video for which a neural representation (e.g., NeRF) is to be trained.

In the example machine-readable instructions and/or the example operations 700, the foregoing processing repeats until the warmup period ends. If the layer selection circuitry 410 determines that the next, subsequent frame of the video for which a neural representation (e.g., NeRF) is to be trained is not within the warmup period, then at block 770 the layer selection circuitry 410 marks the first group of layers 350 of the neural network 300 as trainable and marks the second group of layers 360 of the neural network 300 as frozen. The neural network training circuitry 405 also initializes the number of training iterations to be performed for the current frame. At block 775, the layer selection circuitry 410 determines whether the current frame is within a group of video frames for which round robin selection for unfreezing ones of the frozen layers 360 is to be performed. For example, round robin selection may be performed to enable initial computation of the relative error improvement statistics (e.g., relative loss improvement scores) for the different frozen layers 360 by the score determination circuitry 415. If the current frame is within the group of video frames for which round robin selection is to be performed, at block 780 the layer selection circuitry 410 selects one of the frozen layers 360 to be unfrozen in a round robin manner (e.g., sequentially cycling the selection of the frozen layer to be unfrozen for subsequent frames). The, at block 785, the layer selection circuitry 410 marks the selected frozen layer of the neural network 300 as unfrozen and trainable. Processing then proceeds to block 725 and blocks subsequent thereto at which the neural network training circuitry 405 trains the neural network 300 as described above to generate a neural representation (e.g., NeRF) for the current frame being trained. However, at block 760, the layer selection circuitry 410 will determine that the current frame is outside the warmup period. As such, at block 790, the score determination circuitry 415 will update the relative error improvement statistics by updating the relative loss improvement scores for the selected unfrozen frame.

Returning to block 775, if the layer selection circuitry 410 determines that the current frame outside the group of video frames for which round robin selection for unfreezing ones of the frozen layers 360 is to be performed, at block 795 the layer selection circuitry 410 selects one of the frozen layers 360 to be unfrozen based on the relative error improvement statistics for the frozen layers 360, as described above. Processing then proceeds to block 725 and blocks subsequent thereto at which the neural network training circuitry 405 trains the neural network 300 as described above to generate a neural representation (e.g., NeRF) for the current frame being trained.

FIG. 8 is a block diagram of an example programmable circuitry platform 800 structured to execute and/or instantiate the example machine-readable instructions and/or the example operations of FIGS. 6 and 7A-7B to implement the INV training circuit 400 of FIG. 4. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example neural network training circuitry 405, the example layer selection circuitry 410, the example score determination circuitry 415, the example relative improvement score storage 420, and/or, more generally, the INV training circuit 400. In some examples, the programmable circuitry 812 also implements the neural network 300.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816. In some examples, the volatile memory 814 implements the example training data storage 425.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, the mass storage discs or devices 828 implement the example training data storage 425.

The machine readable instructions 832, which may be implemented by the machine readable instructions of FIGS. 6 and 7A-7B, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6 and 7A-7B to effectively instantiate the circuitry of FIG. 4 as logic circuits to perform operations corresponding to those machine readable instructions. In some such examples, the circuitry of FIG. 4 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6 and 7A-7B.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCle bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 6 and 7A-7B but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6 and 7A-7B. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6 and 7A-7B. As such, the FPGA circuitry 1000 may be configured and/or structured to effectively instantiate some or all of the operations/functions corresponding to the machine readable instructions of the flowchart(s) of FIGS. 6 and 7A-7B as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6 and 7A-7B faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6 and 7A-7B and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCle controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 6 and 7A-7B to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 6 and 7A-7B, and/or an ASIC may be configured and/or structured to perform third operation(s)/function(s) corresponding to a third portion of the machine readable instructions represented by the flowcharts of FIGS. 6 and 7A-7B.

It should be understood that some or all of the circuitry of FIG. 4 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 4 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

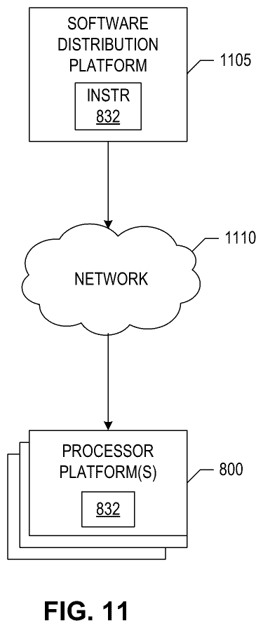

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6 and 7A-7B, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 6 and 7A-7B, may be downloaded to the example programmable circuitry platform 800, which is to execute the machine readable instructions 832 to implement the INV training circuit 400. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement dynamic layer partitioning for incremental training of neural radiance fields. Disclosed systems, apparatus, articles of manufacture, and methods improve the efficiency of using a computing device by selectively freezing and unfreezing the back, color-related layers of the neural network implementing an incremental neural video (INV) multi-layer perceptron (MLP). Such selective freezing and unfreezing substantially improves the peak signal-to-noise ratio (PSNR) performance of the INV MLP for long videos with just marginal extra compute or bandwidth cost. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus to generate a neural video, the apparatus comprising interface circuitry, computer readable instructions, and at least one processor circuit to be programmed by the computer readable instructions to train a neural network based on initial video frames of an input video to generate neural representations of the initial video frames, the neural network having a first group of layers and a second group of layers, the first group of layers to be retrained for subsequent video frames of the video after the initial video frames, the second group of layers to be selectively frozen for the subsequent video frames, select at least one layer of the second group of layers to be unfrozen for a first video frame subsequent to the initial video frames, and retrain the first group of layers and the selected at least one layer of the second group of layers to generate a neural representation of the first video frame, unselected ones of the second group of layers to remain frozen in the neural representation of the first video frame.

Example 2 includes the apparatus of example 1, wherein the at least one layer is at least one first layer of the second group of layers, and one or more of the at least one processor circuit is to select at least one second layer of the second group of layers to be unfrozen for a second video frame subsequent to the first video frame, the at least one second layer different from the at least one first layer, and retrain the first group of layers and the selected at least one second layer of the second group of layers to generate a neural representation of the second video frame, unselected ones of the second group of layers to remain frozen in the neural representation of the second video frame.

Example 3 includes the apparatus of example 1 or example 2, wherein the at least one layer includes at least two layers of the second group of layers.

Example 4 includes the apparatus of any one of examples 1 to 3, wherein one or more of the at least one processor circuit is to select the at least one layer of the second group of layers based on a round-robin procedure.

Example 5 includes the apparatus of any one of examples 1 to 4, wherein one or more of the at least one processor circuit is to select the at least one layer of the second group of layers based on scores determined for respective ones of the second group of layers.

Example 6 includes the apparatus of any one of examples 1 to 5, wherein one or more of the at least one processor circuit is to convert the scores to selection probabilities for the respective ones of the second group of layers, and select the at least one layer of the second group of layers based on the selection probabilities.

Example 7 includes the apparatus of any one of examples 1 to 6, wherein the at least one layer is at least one first layer of the second group of layers, and one or more of the at least one processor circuit is to select the at least one first layer of the second group of layers based on a round-robin procedure, and select at least one second layer of the second group of layers to be unfrozen for a second video frame subsequent to the first video frame, the at least one second layer to be selected based on scores determined for respective ones of the second group of layers.

Example 8 includes the apparatus of any one of examples 1 to 7, wherein the first group of layers includes a first number of front layers of the neural network and the second group of layers includes a second number of back layers if the neural network.

Example 9 includes the apparatus of any one of examples 1 to 8, wherein the first group of layers is associated with motion represented by the neural representations, and the second group of layers is associated with color represented by the neural representations.

Example 10 includes the apparatus of any one of examples 1 to 9, wherein one or more of the at least one processor circuit is to cause the neural representation of the first video frame to be at least one of stored in memory or transmitted to a compute device.

Example 11 includes at least one non-transitory computer readable medium comprising computer readable instructions to cause at least one processor circuity to at least train a neural network based on initial video frames of a video to generate neural representations of the initial video frames, the neural network having a first group of layers and a second group of layers, the first group of layers to be retrained for subsequent video frames of the video after the initial video frames, the second group of layers to be selectively frozen for the subsequent video frames, select at least one layer of the second group of layers to be unfrozen for a first video frame subsequent to the initial video frames, and retrain the first group of layers and the selected at least one layer of the second group of layers to generate a neural representation of the first video frame, unselected ones of the second group of layers to remain frozen in the neural representation of the first video frame.

Example 12 includes the at least one non-transitory computer readable medium of example 11, wherein the at least one layer is at least one first layer of the second group of layers, and the computer readable instructions are to cause one or more of the at least one processor circuit to select at least one second layer of the second group of layers to be unfrozen for a second video frame subsequent to the first video frame, the at least one second layer different from the at least one first layer, and retrain the first group of layers and the selected at least one second layer of the second group of layers to generate a neural representation of the second video frame, unselected ones of the second group of layers to remain frozen in the neural representation of the second video frame.

Example 13 includes the at least one non-transitory computer readable medium of example 11 or example 12, wherein the computer readable instructions are to cause one or more of the at least one processor circuit to select the at least one layer of the second group of layers based on scores determined for respective ones of the second group of layers.

Example 14 includes the at least one non-transitory computer readable medium of any one of examples 11 to 13, wherein the computer readable instructions are to cause one or more of the at least one processor circuit to convert the scores to selection probabilities for the respective ones of the second group of layers, and select the at least one layer of the second group of layers based on the selection probabilities.

Example 15 includes the at least one non-transitory computer readable medium of any one of examples 11 to 14, wherein the at least one layer is at least one first layer of the second group of layers, and the computer readable instructions are to cause one or more of the at least one processor circuit to select the at least one first layer of the second group of layers based on a round-robin procedure, and select at least one second layer of the second group of layers to be unfrozen for a second video frame subsequent to the first video frame, the at least one second layer to be selected based on scores determined for respective ones of the second group of layers.

Example 16 includes a method to generate a neural video, the method comprising training a neural network based on initial video frames of a video to generate neural representations of the initial video frames, the neural network having a first group of layers and a second group of layers, the first group of layers to be retrained for subsequent video frames of the video after the initial video frames, the second group of layers to be selectively frozen for the subsequent video frames, selecting, by at least one processor circuit programmed by at least one instruction, at least one layer of the second group of layers to be unfrozen for a first video frame subsequent to the initial video frames, and retraining, by one or more of the at least one processor circuit, the first group of layers and the selected at least one layer of the second group of layers to generate a neural representation of the first video frame, unselected ones of the second group of layers to remain frozen in the neural representation of the first video frame.

Example 17 includes the method of example 16, wherein the at least one layer is at least one first layer of the second group of layers, and further including selecting at least one second layer of the second group of layers to be unfrozen for a second video frame subsequent to the first video frame, the at least one second layer different from the at least one first layer, and retraining the first group of layers and the selected at least one second layer of the second group of layers to generate a neural representation of the second video frame, unselected ones of the second group of layers to remain frozen in the neural representation of the second video frame.

Example 18 includes the method of example 16 or example 17, wherein the selecting of the at least one layer of the second group of layers is based on scores determined for respective ones of the second group of layers.

Example 19 includes the method of any one of examples 16 to 18, wherein the selecting includes converting the scores to selection probabilities for the respective ones of the second group of layers, and selecting the at least one layer of the second group of layers based on the selection probabilities.

Example 20 includes the method of any one of examples 16 to 19, wherein the at least one layer is at least one first layer of the second group of layers, the selecting of the at least one first layer of the second group of layers is based on a round-robin procedure, and further including selecting at least one second layer of the second group of layers to be unfrozen for a second video frame subsequent to the first video frame, the at least one second layer selected based on scores determined for respective ones of the second group of layers.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to generate a neural video, the apparatus comprising:
interface circuitry;
computer readable instructions; and
at least one processor circuit to be programmed by the computer readable instructions to:
train a neural network based on initial video frames of an input video to generate neural representations of the initial video frames, the neural network having a first group of layers and a second group of layers, the first group of layers to be retrained for subsequent video frames of the video after the initial video frames, the second group of layers to be selectively frozen for the subsequent video frames;
select at least one layer of the second group of layers to be unfrozen for a first video frame subsequent to the initial video frames; and
retrain the first group of layers and the selected at least one layer of the second group of layers to generate a neural representation of the first video frame, unselected ones of the second group of layers to remain frozen in the neural representation of the first video frame.

2. The apparatus of claim 1, wherein the at least one layer is at least one first layer of the second group of layers, and one or more of the at least one processor circuit is to:
select at least one second layer of the second group of layers to be unfrozen for a second video frame subsequent to the first video frame, the at least one second layer different from the at least one first layer; and
retrain the first group of layers and the selected at least one second layer of the second group of layers to generate a neural representation of the second video frame, unselected ones of the second group of layers to remain frozen in the neural representation of the second video frame.

3. The apparatus of claim 1, wherein the at least one layer includes at least two layers of the second group of layers.

4. The apparatus of claim 1, wherein one or more of the at least one processor circuit is to select the at least one layer of the second group of layers based on a round-robin procedure.

5. The apparatus of claim 1, wherein one or more of the at least one processor circuit is to select the at least one layer of the second group of layers based on scores determined for respective ones of the second group of layers.

6. The apparatus of claim 5, wherein one or more of the at least one processor circuit is to:
convert the scores to selection probabilities for the respective ones of the second group of layers; and
select the at least one layer of the second group of layers based on the selection probabilities.

7. The apparatus of claim 1, wherein the at least one layer is at least one first layer of the second group of layers, and one or more of the at least one processor circuit is to:
select the at least one first layer of the second group of layers based on a round-robin procedure; and
select at least one second layer of the second group of layers to be unfrozen for a second video frame subsequent to the first video frame, the at least one second layer to be selected based on scores determined for respective ones of the second group of layers.

8. The apparatus of claim 1, wherein the first group of layers includes a first number of front layers of the neural network and the second group of layers includes a second number of back layers if the neural network.

9. The apparatus of claim 1, wherein the first group of layers is associated with motion represented by the neural representations, and the second group of layers is associated with color represented by the neural representations.

10. The apparatus of claim 1, wherein one or more of the at least one processor circuit is to cause the neural representation of the first video frame to be at least one of stored in memory or transmitted to a compute device.

11. At least one non-transitory computer readable medium comprising computer readable instructions to cause at least one processor circuity to at least:
train a neural network based on initial video frames of a video to generate neural representations of the initial video frames, the neural network having a first group of layers and a second group of layers, the first group of layers to be retrained for subsequent video frames of the video after the initial video frames, the second group of layers to be selectively frozen for the subsequent video frames;
select at least one layer of the second group of layers to be unfrozen for a first video frame subsequent to the initial video frames; and
retrain the first group of layers and the selected at least one layer of the second group of layers to generate a neural representation of the first video frame, unselected ones of the second group of layers to remain frozen in the neural representation of the first video frame.

12. The at least one non-transitory computer readable medium of claim 11, wherein the at least one layer is at least one first layer of the second group of layers, and the computer readable instructions are to cause one or more of the at least one processor circuit to:
select at least one second layer of the second group of layers to be unfrozen for a second video frame subsequent to the first video frame, the at least one second layer different from the at least one first layer; and
retrain the first group of layers and the selected at least one second layer of the second group of layers to generate a neural representation of the second video frame, unselected ones of the second group of layers to remain frozen in the neural representation of the second video frame.

13. The at least one non-transitory computer readable medium of claim 11, wherein the computer readable instructions are to cause one or more of the at least one processor circuit to select the at least one layer of the second group of layers based on scores determined for respective ones of the second group of layers.

14. The at least one non-transitory computer readable medium of claim 13, wherein the computer readable instructions are to cause one or more of the at least one processor circuit to:
convert the scores to selection probabilities for the respective ones of the second group of layers; and
select the at least one layer of the second group of layers based on the selection probabilities.

15. The at least one non-transitory computer readable medium of claim 11, wherein the at least one layer is at least one first layer of the second group of layers, and the computer readable instructions are to cause one or more of the at least one processor circuit to:
select the at least one first layer of the second group of layers based on a round-robin procedure; and
select at least one second layer of the second group of layers to be unfrozen for a second video frame subsequent to the first video frame, the at least one second layer to be selected based on scores determined for respective ones of the second group of layers.

16. A method to generate a neural video, the method comprising:
training a neural network based on initial video frames of a video to generate neural representations of the initial video frames, the neural network having a first group of layers and a second group of layers, the first group of layers to be retrained for subsequent video frames of the video after the initial video frames, the second group of layers to be selectively frozen for the subsequent video frames;
selecting, by at least one processor circuit programmed by at least one instruction, at least one layer of the second group of layers to be unfrozen for a first video frame subsequent to the initial video frames; and
retraining, by one or more of the at least one processor circuit, the first group of layers and the selected at least one layer of the second group of layers to generate a neural representation of the first video frame, unselected ones of the second group of layers to remain frozen in the neural representation of the first video frame.

17. The method of claim 16, wherein the at least one layer is at least one first layer of the second group of layers, and further including:
selecting at least one second layer of the second group of layers to be unfrozen for a second video frame subsequent to the first video frame, the at least one second layer different from the at least one first layer; and
retraining the first group of layers and the selected at least one second layer of the second group of layers to generate a neural representation of the second video frame, unselected ones of the second group of layers to remain frozen in the neural representation of the second video frame.

18. The method of claim 16, wherein the selecting of the at least one layer of the second group of layers is based on scores determined for respective ones of the second group of layers.

19. The method of claim 18, wherein the selecting includes:
converting the scores to selection probabilities for the respective ones of the second group of layers; and
selecting the at least one layer of the second group of layers based on the selection probabilities.

20. The method of claim 16, wherein the at least one layer is at least one first layer of the second group of layers, the selecting of the at least one first layer of the second group of layers is based on a round-robin procedure, and further including selecting at least one second layer of the second group of layers to be unfrozen for a second video frame subsequent to the first video frame, the at least one second layer selected based on scores determined for respective ones of the second group of layers.
